(19) United States
(12) Patent Application Publication
(10) Pub. No.: US 2025/0047530 A1
(43) Pub. Date: Feb. 6, 2025

(54) EXTENDED WIRELESS SIGNAL PROCESSING

(71) Applicant: QUALCOMM Incorporated, San Diego, CA (US)

(72) Inventors: Ziv ALINA, Rishon le Zion (IL); Shay LANDIS, Hod Hasharon (IL); Gennady ZILBERMAN, Hod-Hasharon (IL); Meir MAROCK, Kfar Saba (IL)

(21) Appl. No.: 18/365,801

(22) Filed: Aug. 4, 2023

(51) Int. Cl. H04L 25/03; H04L 1/00; H04L 5/00

(52) U.S. Cl. CPC H04L 25/03006; H04L 1/0003; H04L 5/0051

(57) ABSTRACT

Aspects of the disclosure are directed to methods for improving data reliability in a wireless network. In some examples, a wireless node may obtain a wireless signal. In some examples, a wireless node may filter the wireless signal via an iterative interference cancelation process. In some examples, a wireless node may decode the filtered wireless signal, wherein the filtering and decoding are performed within a first time window indicated by a non-legacy signal processing requirement.

### BACKGROUND

### Technical Field

The present disclosure generally relates to communication systems, and more particularly, to wireless signal processing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method of wireless communication at a wireless node, including: obtaining a wireless signal; filtering the wireless signal via an iterative interference cancelation process; and decoding the filtered wireless signal, wherein the filtering and decoding are performed within a first time window indicated by a non-legacy signal processing requirement.

In some aspects, the techniques described herein relate to a method of wireless communication at a first wireless node, including: outputting a wireless signal for transmission to a second wireless node; and outputting, for transmission to the second wireless node, an indication of scheduled resources, wherein the scheduled resources are outside of a first time window indicated by a non-legacy signal processing requirement of the second wireless node.

In some aspects, the techniques described herein relate to an apparatus for wireless communication, including: one or more memories, individually or in combination, having instructions; and one or more processors, individually or in combination, configured to execute the instructions and cause the apparatus to: obtain a wireless signal; filter the wireless signal via an iterative interference cancelation process; and decode the filtered wireless signal, wherein the filtering and decoding are performed within a first time window indicated by a non-legacy signal processing requirement.

In some aspects, the techniques described herein relate to an apparatus for wireless communication, including: one or more memories, individually or in combination, having instructions; and one or more processors, individually or in combination, configured to execute the instructions and cause the apparatus to: output a wireless signal for transmission to a wireless node; and output, for transmission to the wireless node, an indication of scheduled resources, wherein the scheduled resources are outside of a first time window indicated by a non-legacy signal processing requirement of the wireless node.

In some aspects, the techniques described herein relate to a method of wireless communication at a wireless node, including: obtaining a wireless signal; filtering the wireless signal via an iterative interference cancelation process; and decoding the filtered wireless signal, wherein the filtering and decoding are performed within a first time window indicated by a non-legacy signal processing requirement.

In some aspects, the techniques described herein relate to a method of wireless communication at a first wireless node, including: outputting a wireless signal for transmission to a second wireless node; and outputting, for transmission to the second wireless node, an indication of scheduled resources, wherein the scheduled resources are outside of a first time window indicated by a non-legacy signal processing requirement of the second wireless node.

In some aspects, the techniques described herein relate to a non-transitory, computer-readable medium comprising computer executable code, the code when executed by one or more processors causes the one or more processors to, individually or in combination: obtain a wireless signal; filter the wireless signal via an iterative interference cancelation process; and decode the filtered wireless signal, wherein the filtering and decoding are performed within a first time window indicated by a non-legacy signal processing requirement.

In some aspects, the techniques described herein relate to a non-transitory, computer-readable medium comprising computer executable code, the code when executed by one or more processors causes the one or more processors to, individually or in combination: output a wireless signal for transmission to a second wireless node; and output, for transmission to the second wireless node, an indication of scheduled resources, wherein the scheduled resources are outside of a first time window indicated by a non-legacy signal processing requirement of the second wireless node.

In some aspects, the techniques described herein relate to an apparatus for wireless communication, including: means for obtaining a wireless signal; means for filtering the wireless signal via an iterative interference cancelation process; and means for decoding the filtered wireless signal, wherein the filtering and decoding are performed within a first time window indicated by a non-legacy signal processing requirement.

In some aspects, the techniques described herein relate to an apparatus for wireless communication, including: means for outputting a wireless signal for transmission to a second wireless node; and means for outputting, for transmission to the second wireless node, an indication of scheduled resources, wherein the scheduled resources are outside of a first time window indicated by a non-legacy signal processing requirement of the second wireless node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example of an iterative process of multiple types of interference cancellation techniques.

FIG. 6 is a block diagram conceptually illustrating an example of an interference cancelation algorithm.

FIG. 7 is a table illustrating an example of legacy decoding requirements of a wireless node.

FIG. 8 is a table illustrating an example of non-legacy decoding requirements of a wireless node.

FIG. 9 is a table illustrating another example of non-legacy decoding requirements of a wireless node.

FIG. 10 is a flowchart of a method of wireless communication.

FIG. 11 is a diagram illustrating another example of a hardware implementation for an example apparatus.

FIG. 12 is a flowchart of a method of wireless communication.

FIG. 13 is a diagram illustrating an example of a hardware implementation for another apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure are directed to wireless signal processing. Improving spectral efficiency (e.g., bandwidth efficiency) is an ongoing pursuit in wireless communications technology. For example, a cellular network's spectral efficiency may be defined as the maximum number of bits of data that can be transmitted to one or more users per second while maintaining an acceptable quality of service. However, as orders of modulation continue to increase, a lower noise floor may improve reliability and successful decoding of received signals. For example, increasing spectral efficiency through high-order modulations (e.g., 1K QAM and greater) may be inhibited by several types of noise floor: power amplifier (PA) non-linearity distortion floor, phase noise floor, in-phase and quadrature (IQ) imbalance floor, and other analog sources of noise.

Another ongoing pursuit involves reducing power consumption of wireless devices, including user equipment (UE) and base station nodes. In some cases, the power amplifier is one of the most power-hungry components of a wireless device. Power consumption of a power amplifier is even more acute in massive multiple-input and multiple-output (MIMO) scenarios, as it requires a large number of transmitters, and thus, a large number of PAs. The power amplifier is also a source of non-linearity distortion. Unfortunately, reducing distortion caused by the power amplifier requires an increased voltage supply to the power amplifier. Another transmitter side technique for reducing noise interference of the power amplifier is digital pre-distortion (DPD). However, DPD reduces the average output power transmitted signals, negatively affecting link budget.

Receiver side techniques can mitigate impairments (such as phase noise or IQ imbalance) that cause noise floors limiting high order modulations. In addition, receiver side techniques are another solution for non-linear interference that does not require additional power to the PA or result in a negative link budget impact. For example, signal distortions may be mitigated at the receiver using iterative noise-cancelation or filtering techniques. Thus, the receiver may use an interactive process wherein each iteration of the process estimates noise and subtracts it from the received signal.

In some cases, such as in higher-order modulation communications, iterative noise cancelation may introduce a degree of latency associated with decoding a received signal. Thus, aspects of the disclosure are directed to introducing a more relaxed signal processing time at the receiver. Therefore, the challenges (e.g., lowering PA power consumption and link budget impacts) of reducing noise in higher-order modulation communication and improving spectral efficiency can be realized with optimized processing time requirements for receiver devices.

Certain aspects of the disclosure relate to new (e.g., non-legacy) elements (e.g., downlink channel decoding time) defining one or more time windows within which a wireless node is required to decode a received signal. Such non-legacy elements may conform, for example, to a first communication standard (e.g., 3GPP Release-18 and subsequent releases). Other aspects of the disclosure describe legacy elements that conform to a second communication standard (e.g., 3GPP Release 17 and prior releases).

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

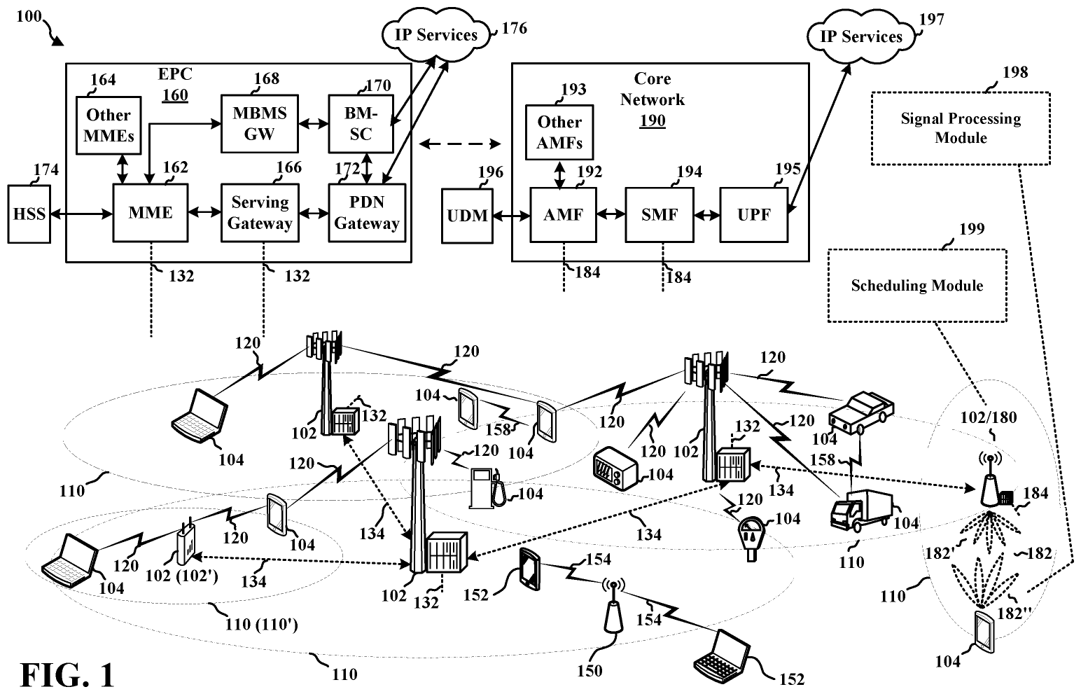

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity of the base station.

Referring again to FIG. 1, the UE 104 may include a signal processing module 198. As described in more detail elsewhere herein, the signal processing module 198 may be configured to obtain a wireless signal; filter the wireless signal via an iterative interference cancelation process; and decode the filtered wireless signal, wherein the filtering and decoding are performed within a first time window indicated by a non-legacy signal processing requirement. Additionally, or alternatively, the signal processing module 198 may perform one or more other operations described herein.

The base station 102/180 may include a scheduling module 199. As described in more detail elsewhere herein, the scheduling module may be configured to obtain an indication of scheduled resources; and output an acknowledgment of the wireless signal for transmission, wherein the scheduled resources are outside of the first time window indicated by the non-legacy signal processing requirement. Additionally, or alternatively, the scheduling module 199 may perform one or more other operations described herein.

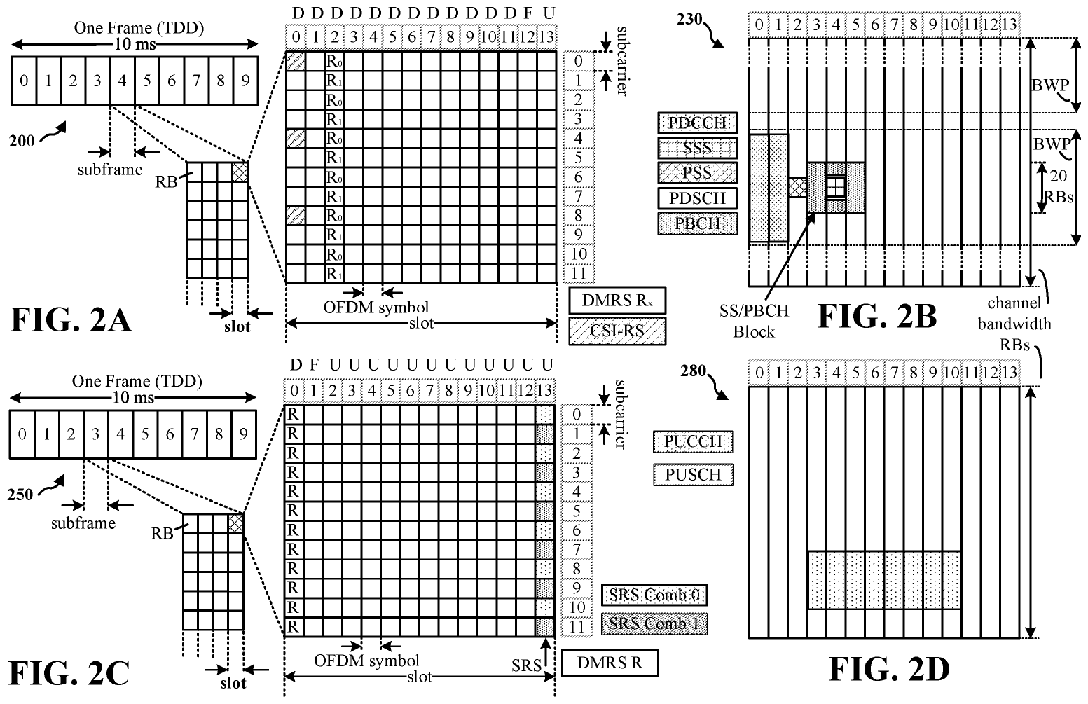

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

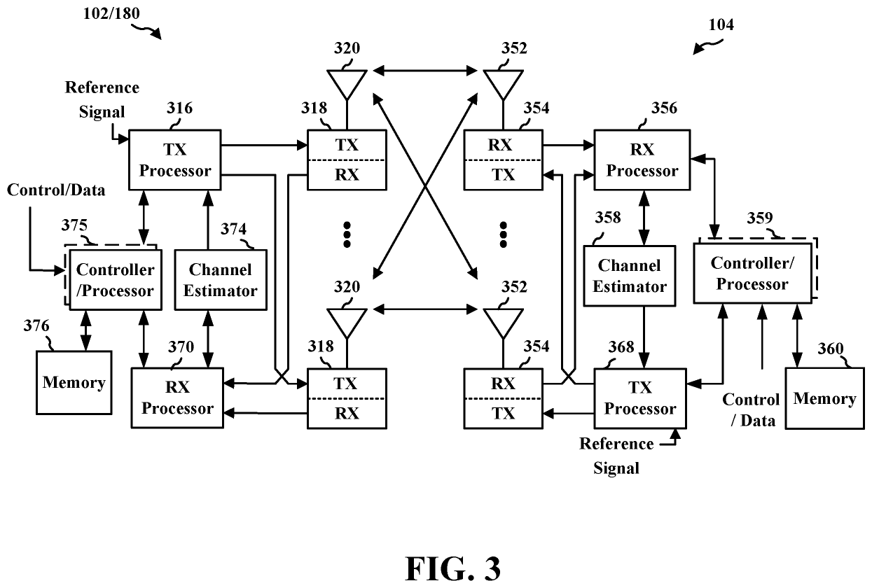

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

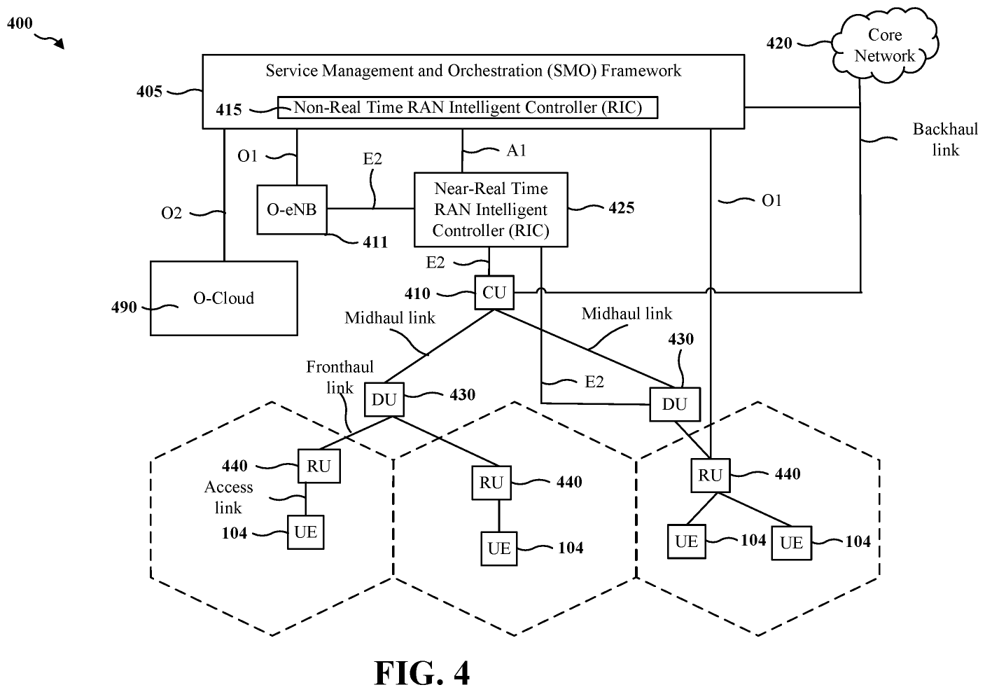

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of an Iterative Interference Cancelation Process

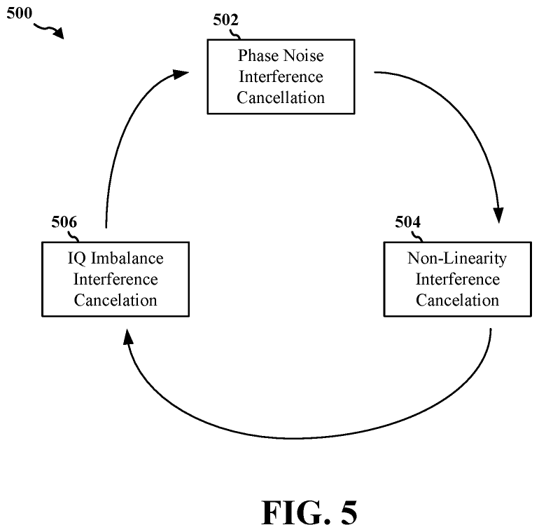

FIG. 5 is a block diagram illustrating an example of an iterative process 500 of multiple types of interference cancellation techniques. It should be noted that although the iterative process 500 includes three types of interference cancelation techniques, such a performance may include fewer or more techniques, and the techniques may include any suitable interference cancelation algorithms used in any suitable order of performance and in any number of iterations. The iterative process 500 may be performed by a wireless node (e.g., UE 104 of FIGS. 1, 3, and 4) on a signal received by that wireless device from a network entity (e.g., base station 102/180 of FIGS. 1 and 3, or an RU 440, DU 430, or CU 410 of FIG. 4).

The iterative process 500 includes a phase noise interference cancelation algorithm 502. The phase noise interference cancelation algorithm 502 may be performed to remove phase noise from a received signal. In some examples, one or more of the network entity and the wireless node may use an imperfect oscillator that adds phase noise to a signal when it is generated by the transmitted and/or received by the receiver. Accordingly, the phase noise interference cancelation algorithm 502 may be configured to reduce or eliminate such phase noise of a signal received by the wireless node.

The iterative process 500 includes a non-linearity interference cancelation algorithm 504. Non-linear interference may be generated by a non-linear PA of the network entity. For example, the PA may not be linear because its amplifying response is dependent on the signal. Thus, certain ranges of the signal may be amplified by a first factor, and another range of the signal may be amplified by a second factor. Thus, the amplified signal that is transmitted by the network entity may have some degree of non-linear distortion when it is received by the wireless node. Accordingly, the non-linearity interference cancelation algorithm 504 may be configured to reduce or eliminate such non-linear interference of a signal received by the wireless node.

The iterative process 500 includes an IQ imbalance interference cancelation algorithm 506. IQ imbalance may manifest in a signal received by the wireless node as a result of an imperfect delay of phase and/or imperfect match of gain between a quadrature component and an in-phase component of the received signal. Accordingly, the IQ imbalance interference cancelation algorithm 506 may be configured to reduce or eliminate such IQ imbalance interference of a signal received by the wireless node.

The iterative process 500 may be performed by a wireless node on a signal received by the wireless node. That is, a receiving device may perform the iterative process on a received signal. In some examples, the wireless node may be configured to determine which type of interference (e.g., phase noise, IQ imbalance, non-linearity noise, etc.) is the most dominant interference in the received signal. For example, the receiving device may estimate each type of interference on one or more reference signals in the received signal or the wireless device may perform a procedure with the transmitting device to make such a determination.

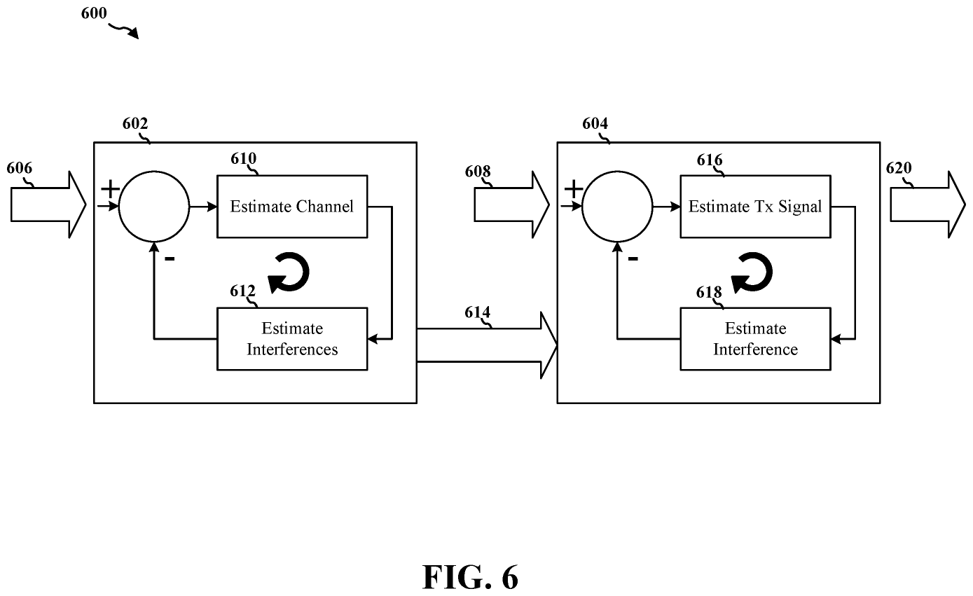

FIG. 6 is a block diagram conceptually illustrating an example of an interference cancelation algorithm 600 (e.g., the phase noise interference cancelation algorithm 502, the non-linearity interference cancelation algorithm 504, the IQ imbalance interference cancelation algorithm 506, and any other suitable interference/noise cancelation algorithm) of a wireless node.

The interference cancelation algorithm 600 includes an iterative reference signal noise cancelation module 602 and an iterative data noise cancelation module 604. Initially, the wireless node may receive a signal transmitted by a network entity. The received signal may include one or more pilot or reference signals 606, and a data signal 608. The noise cancelation module 602 may receive the reference signal 606 of the received signal as an input. Initially, the noise cancelation module 602 may estimate channel conditions 610 based on the reference signal 606 input. The noise cancelation module 602 may then estimate one or more types of interference (e.g., phase noise, non-linearity, IQ imbalance, etc.) 612 of the reference signal 606 input, and subtract the estimated interference(s) from the reference signal 606 input. The reference signal noise cancelation module 602 may perform multiple iterations on a reference signal 606 to filter a greater amount of interference from the reference signal than if the reference signal experienced only one cycle. For example, in a first iteration, the noise cancelation module 602 may subtract an estimated non-linear distortion. In a second iteration, the noise cancellation module 602 may subtract one or more of another estimated non-linear distortion, a estimated phase noise distortion, and/or an estimated IQ imbalance. Thus, interference(s) of the same signal may be estimated multiple times and subtracted from the raw reference signal 606 multiple times.

The data noise cancelation module 604 may receive the raw data signal 608 of the received signal as input, as well as the estimated channel 614. Initially, the data noise cancelation module 604 may use the channel estimate to estimate 616 the transmitted data signal. The data noise cancelation module 604 may then estimate the interference 618 (e.g., phase noise, non-linearity, IQ imbalance, etc.) of the data signal 608 input, and subtract the estimated interference from the raw data signal 608. The data noise cancelation module 604 may perform multiple iterations of the same cycle on a data signal 608 to filter a greater amount of interference from the data signal than if the data signal experienced only one cycle. Thus, interference of the same signal may be estimated multiple times and subtracted from the raw data signal multiple times. A data signal with a suppressed noise floor may then be output from the data noise cancelation module 604. The suppressed data signal 620 may then be input into another noise cancelation module (e.g., to reduce a different type of interference) or input to another module for demodulation/decoding of the data signal.

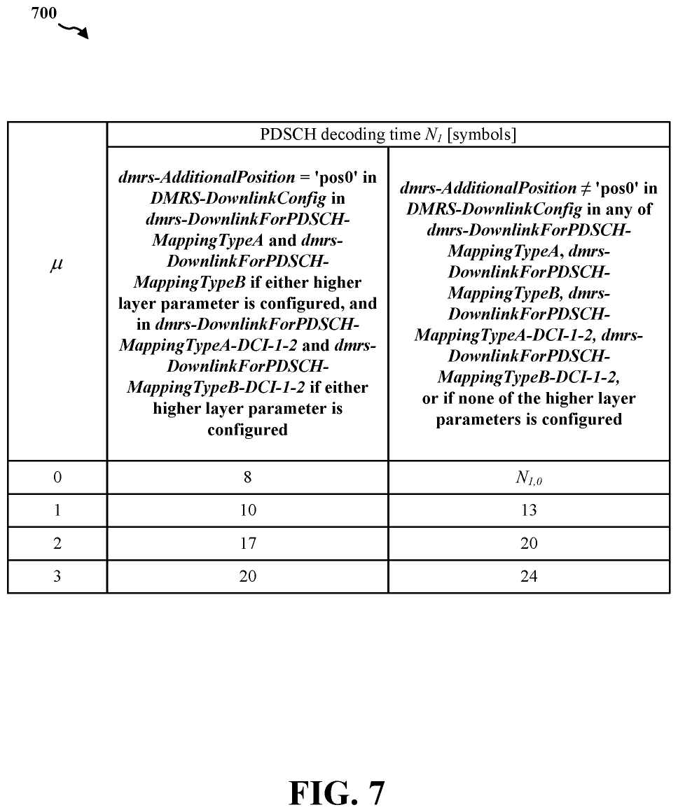

FIG. 7 is a table illustrating an example of legacy decoding requirements 700 of a wireless node. In some examples, a network entity may configure the wireless node, or the wireless node may be pre-configured with multiple decoding times based on different subcarrier spacing (SCS) values. As illustrated in the example of FIG. 7, SCS values are shown as μ, where the corresponding values 0, 1, 2, and 3 may be mapped to different SCSs (e.g., 15 kHz, 30 kHz, 60 kHz, and 120 kHz).

As illustrated, each decoding time associated with a particular SCS value may define a number of symbols (e.g., a time window, N₁) within which the wireless node is required to be ready to transmit an ACK/NACK in response to the received signal. For example, the time window indicates a duration of time within which the wireless node is required to filter (e.g., remove noise/interference as described above in reference to FIGS. 5 and 6) and decode a received signal. In one example, the time window may begin when the wireless entity receives the last reference signal (e.g., DMRS) of a received signal (e.g., the last DMRS of a slot). Accordingly, for the purpose of determining a time window for filtering and decoding a received signal, a quantity of symbols defining the time window may be measured from the end of the last reference signal symbol received.

Thus, according to the illustrated table, if the received signal has an SCS of 120 KHz (e.g., μ=3), the wireless node will have a time window of 20 contiguous symbols beginning at the symbol immediately following the symbol carrying the last reference signal received. In some examples, the table may associate different reference signal patterns and/or reference signal slot positions with different time windows. As illustrated in FIG. 7, a first DMRS (e.g., dmrs-AdditionalPosition=pos0) is associated with N₁=8, 10, 17, or 20, whereas a second DMRS (e.g., dmrs-AdditionalPosition≠pos0) is associated with N₁=N_{1,0},13, 20, or 24.

It should be noted that the network entity is aware of decoding requirements 700 of the wireless node. The network entity may be required to schedule resources for the wireless node's ACK/NACK transmission such that the scheduled resources occur after a time window defined by the decoding requirements 700. Thus, the wireless node may not expect to be scheduled with ACK/NACK resources that occur within the time window defined by the decoding requirements.

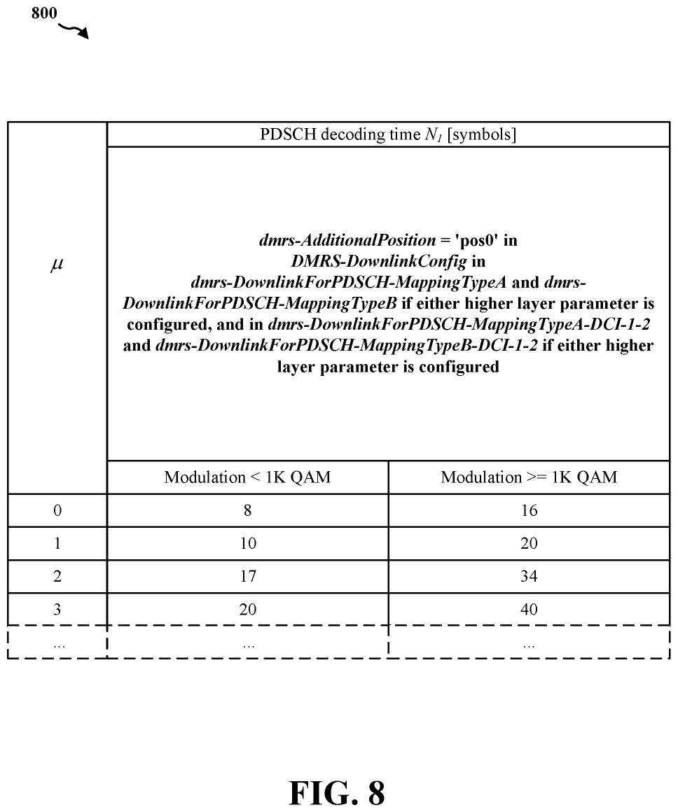

FIG. 8 is a table illustrating an example of non-legacy decoding requirements 800 of a wireless node. In some examples, a network entity may configure the wireless node, or the wireless node may be pre-configured with multiple decoding times based on different subcarrier spacing (SCS) values, as defined by the table. As illustrated in the example of FIG. 8, SCS values are shown as u, where the corresponding values 0, 1, 2, and 3 may be mapped to different SCSs (e.g., 15 kHz, 30 kHz, 60 kHz, and 120 kHz). Although four different SCS values are shown, the table may include any suitable number of SCS values including more or fewer values than shown.

Compared to the legacy decoding requirements 700 of FIG. 7, the non-legacy decoding requirements 800 define decoding time windows (e.g., N₁) as a function of a modulation scheme used to transmit the received signal. The higher order modulation schemes may correspond to time windows having relatively longer durations compared to lower order modulation schemes. This provides the wireless node with additional time to filter (e.g., increased number of iterations in an interference cancelation process) a received signal as the modulation order increases, thereby suppressing noise floor below the level required for legacy modulation order.

As illustrated, if the modulation scheme used for transmitting a signal received by the wireless node is less than 1K-QAM (e.g., 16/64/256-QAM), then the time window for decoding the received signal is 8 symbols, 10 symbols, 17 symbols, or 20 symbols, based on the SCS of the received signal. However, if the signal received by the wireless node is greater than or equal to 1K-QAM (e.g., 1K/4K-QAM), then the time window for decoding the received signal is 16 symbols, 20 symbols, 34 symbols, or 40 symbols, based on the SCS of the received signal. Accordingly, the wireless node that receives the signal transmitted using a higher order QAM (e.g., 1K-QAM) is provided with more time to perform additional filtering iterations (e.g., described and illustrated in FIGS. 5 and 6) to improve the received signal prior to decoding. It should be noted that various time windows may be defined by any suitable number of symbols (e.g., N₁) and are not limited to the examples shown in FIG. 8. Similarly, the non-legacy decoding requirements 800 may associate different reference signal patterns and/or reference signal slot positions with different time windows. As such, the non-legacy decoding requirements may include additional time window durations (N₁) corresponding to different values of dmrs-AdditionalPosition.

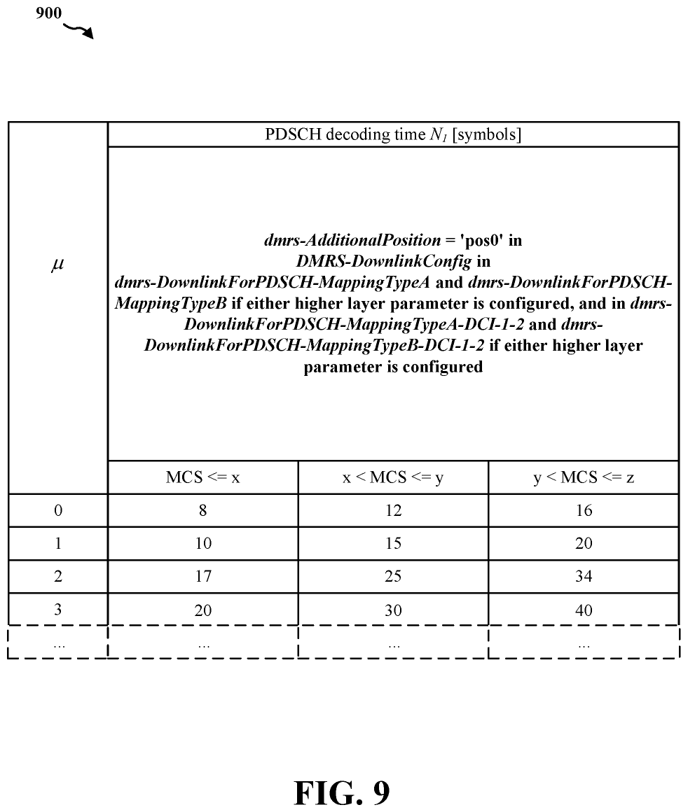

FIG. 9 is a table illustrating another example of non-legacy decoding requirements 900 of a wireless node. Although four different SCS values are shown, the table may include any suitable number of SCS values (μ) including more or fewer values than shown.

Compared to the legacy decoding requirements 700 of FIG. 7, the non-legacy decoding requirements 900 define decoding time windows (e.g., N₁) as a function of a modulation and coding scheme (MCS) used to transmit the received signal. The higher order MCSs may correspond to time windows having relatively longer durations compared to lower order MCSs. This provides the wireless node with additional time to filter (e.g., increased number of iterations in an interference cancelation process) a received signal as the MCS order increases, thereby suppressing noise floor below the level required for legacy MCS order.

As illustrated, if the MCS used for transmitting a signal received by the wireless node is less than x (e.g., where x is an index value mapped to an MCS), then the time window for decoding the received signal is 8 symbols, 10 symbols, 17 symbols, or 20 symbols, based on the SCS of the received signal. If the signal received by the wireless node was transmitted using an MCS greater than x and less than or equal to y (e.g., where y is another index value mapped to an MCS having a higher order than x), then the time window for decoding the received signal is 12 symbols, 15 symbols, 25 symbols, or 30 symbols, based on the SCS of the received signal. Accordingly, the wireless node that receives the signal transmitted using a higher order MCS is provided with more time to perform additional filtering iterations (e.g., described and illustrated in FIGS. 5 and 6) relative to a lower order MCS, to improve the received signal prior to decoding. Similarly, if the signal received by the wireless node was transmitted using an MCS greater than y and less than or equal to z (e.g., where z is another index value mapped to an MCS having a higher order than x and y), then the time window for decoding the received signal is 16 symbols, 20 symbols, 34 symbols, or 40 symbols, based on the SCS of the received signal.

It should be noted that various time windows may be defined by any suitable number of symbols (e.g., N₁) and are not limited to the examples shown in FIG. 9. Similarly, the non-legacy decoding requirements 900 may associate different reference signal patterns and/or reference signal slot positions with different time windows. As such, the non-legacy decoding requirements may include additional time window durations (N₁) corresponding to different values of dmrs-AdditionalPosition.

Although the non-legacy decoding requirements illustrated in FIGS. 8 and 9 define decoding time windows (e.g., N₁) as a function of QAM and MCS, it should be noted that the decoding time windows may be defined as a function of any suitable modulation and/or coding scheme used to transmit the signal received by the wireless node.

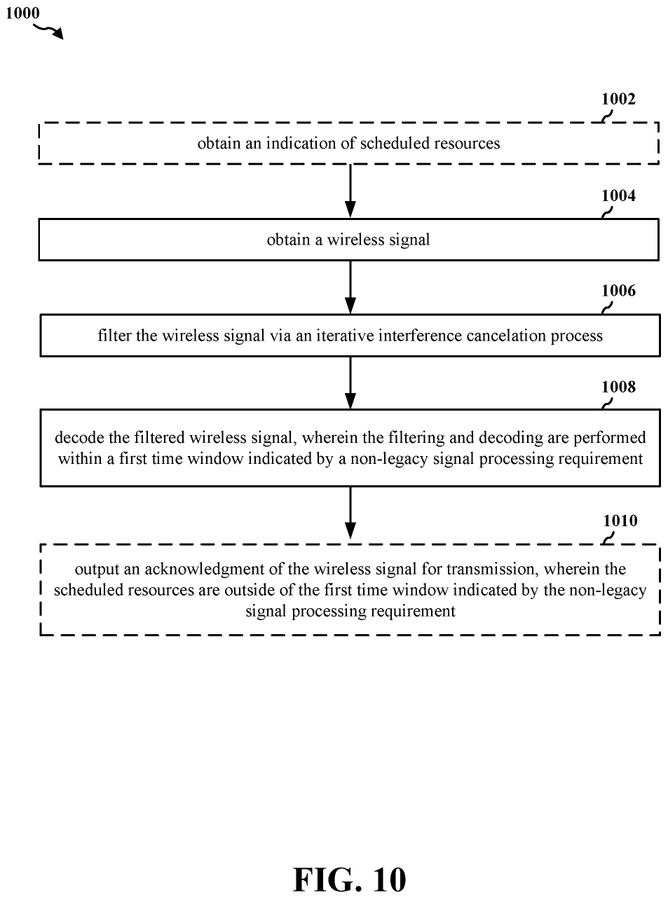

FIG. 10 is a flowchart 1000 of a method of wireless communication. The method may be performed by a UE (e.g., the UE 104; the apparatus 1102).

At 1002, the UE may optionally obtain an indication of scheduled resources. For example, 1002 may be performed by scheduling component 1140. Here, the UE may receive an indication of uplink resources it may use to transmit an ACK/NACK in response to a downlink communication. However, the UE does not expect to be scheduled to ACK the wireless signal prior to a time window provided by a non-legacy requirement table (e.g., tables illustrated in FIGS. 8 and 9).

At 1004, the UE may obtain a wireless signal. For example, 1004 may be performed by an obtaining component 1142. Here, the UE may receive a downlink signal transmitted by a network entity. The UE may have uplink resources for transmitting an ACK/NACK to the network entity indicating whether the UE properly received the downlink transmission. In this example, the uplink resources may occur outside of a larger time window (relative to legacy requirements) for decoding the downlink transmission. Thus, the UE has relatively more time to perform iterative interference processes.

At 1006, the UE may filter the wireless signal via an iterative interference cancelation process. For example, 1006 may be performed by a filtering component 1144. Here, the UE may have more time to process a downlink signal than legacy requirements allow. For example, the UE may perform one or more of the noise cancelation processes illustrated in FIGS. 5 and 6.

At 1008, the UE may decode the filtered wireless signal, wherein the filtering and decoding are performed within a first time window indicated by a non-legacy signal processing requirement. For example, 1008 may be performed by a decoding component 1146. Here, the UE may be provided with a longer time period (relative to legacy requirements) for decoding a received downlink signal.

Finally, at 1010, the UE may output an acknowledgment of the wireless signal for transmission, wherein the scheduled resources are outside of the first time window indicated by the non-legacy signal processing requirement. For example, 1010 may be performed by an outputting component 1148. Here, the UE may transmit an indication of whether it properly received the downlink signal (e.g., ACK/NACK).

In certain aspects, the first time window is a function of at least one of a first modulation scheme of the wireless signal or a first subcarrier spacing (SCS) of the wireless signal. In other words, the various time windows (e.g., symbols within which the UE must filter and decode the downlink signal) may relate to a modulation scheme and/or an SCS used to transmit the downlink signal and/or the uplink signal in response.

In certain aspects, the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs). In other words, non-legacy requirements may include a plurality of different time windows, modulation schemes, and/or SCSs.

In certain aspects, the plurality of modulation schemes comprise a first modulation range and a second modulation range, and wherein the plurality of time windows comprise at least a first subset of time windows associated with the first modulation range and a second subset of time windows associated with the second modulation range. For example, FIGS. 8 and 9 illustrate tables having different time windows associated with different modulation ranges.

In certain aspects, the plurality of modulation schemes comprise a first modulation and coding scheme (MCS) range and a second MCS range, and wherein the plurality of time windows comprise at least a first subset of time windows associated with the first MCS range and a second subset of time windows associated with the second MCS range.

In certain aspects, the first time window indicated by the non-legacy signal processing requirement is greater than a corresponding second time window of a legacy signal processing requirement. That is, a distinction between the non-legacy time window and the legacy time window is that the legacy time windows are a narrower time window.

In certain aspects, the iterative interference cancelation process comprises one or more of a phase noise interference cancelation algorithm, an in-phase and quadrature (IQ) imbalance interference cancelation algorithm, and a non-linearity interference cancelation algorithm.

In certain aspects, the wireless signal comprises one or more demodulation reference signals (DMRSs), and wherein the first time window is indicated by the non-legacy signal processing requirement in terms of contiguous symbols starting at a symbol via which a last DMRS of the one or more DMRSs is obtained by the wireless node.

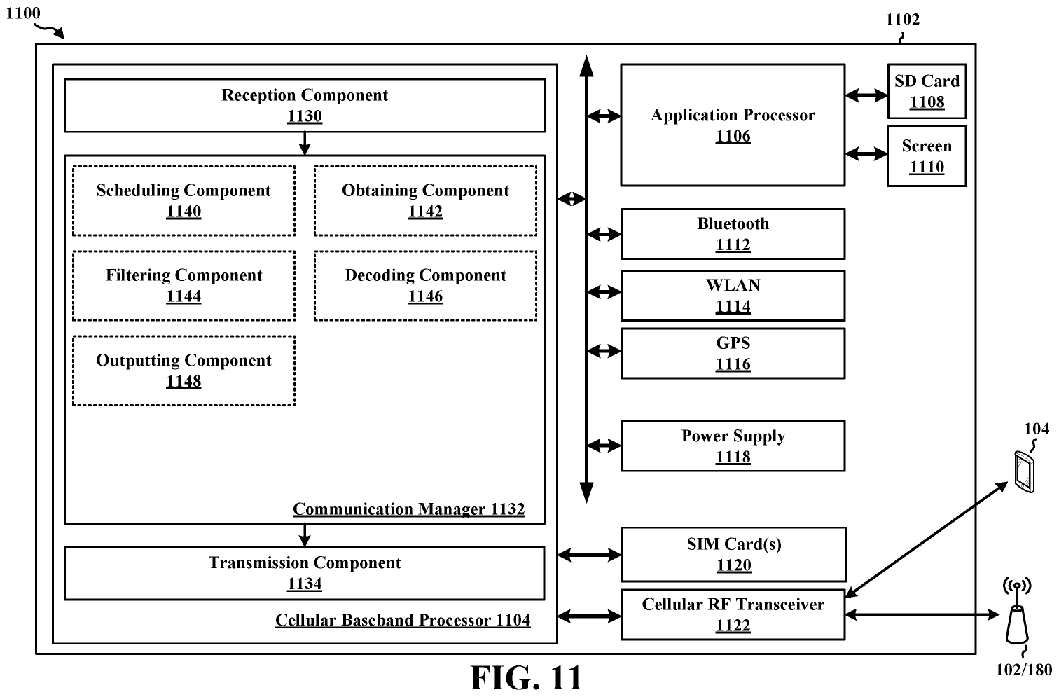

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 104 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see UE 104 of FIG. 3) and include the aforediscussed additional modules of the apparatus 1102.

In various examples, the apparatus 1102 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1132 includes a scheduling component 1140 that is configured to obtain an indication of scheduled resources, e.g., as described in connection with 1002. The communication manager 1132 further includes an obtaining component 1142 configured to obtain a wireless signal, e.g., as described in connection with 1004. The communication manager 1132 further includes a filtering component 1144 configured to filter the wireless signal via an iterative interference cancelation process, e.g., as described in connection with 1006. The communication manager 1132 includes a decoding component 1146 that is configured to decode the filtered wireless signal, wherein the filtering and decoding are performed within a first time window indicated by a non-legacy signal processing requirement, e.g., as described in connection with 1008. The communication manager 1132 includes an outputting component 1148 that is configured to output an acknowledgment of the wireless signal for transmission, wherein the scheduled resources are outside of the first time window indicated by the non-legacy signal processing requirement, e.g., as described in connection with 1010.

The apparatus may include additional components that perform each of the blocks of the algorithm in the aforementioned flowchart of FIG. 10. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes: means for obtaining an indication of scheduled resources; means for obtaining a wireless signal; means for filtering the wireless signal via an iterative interference cancelation process; means for decode the filtered wireless signal, wherein the filtering and decoding are performed within a first time window indicated by a non-legacy signal processing requirement; and means for output an acknowledgment of the wireless signal for transmission, wherein the scheduled resources are outside of the first time window indicated by the non-legacy signal processing requirement.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

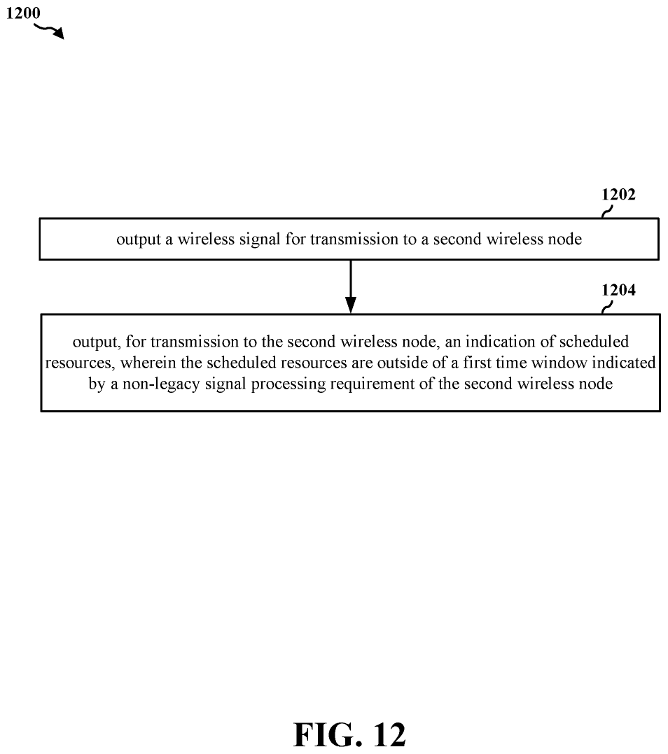

FIG. 12 is a flowchart 1200 of a method of wireless communication. The method may be performed by a wireless node (e.g., the base station 102/180; another UE 104; the apparatus 1302.

At 1202, the wireless node may output a wireless signal for transmission to a second wireless node. For example, 1202 may be performed by an outputting component 1340.

At 1204, the wireless node may output, for transmission to the second wireless node, an indication of scheduled resources, wherein the scheduled resources are outside of a first time window indicated by a non-legacy signal processing requirement of the second wireless node. For example, 1204 may be performed by the outputting component 1340.

In certain aspects, the first time window is a function of at least one of a first modulation scheme of the wireless signal or a first subcarrier spacing (SCS) of the wireless signal.

In certain aspects, the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

In certain aspects, the plurality of modulation schemes comprises a first modulation range and a second modulation range, and wherein the plurality of time windows comprise at least a first subset of time windows associated with the first modulation range and a second subset of time windows associated with the second modulation range.

In certain aspects, the plurality of modulation schemes comprises a first modulation and coding scheme (MCS) range and a second MCS range, and wherein the plurality of time windows comprise at least a first subset of time windows associated with the first MCS range and a second subset of time windows associated with the second MCS range.

In certain aspects, the first time window indicated by the non-legacy signal processing requirement is greater than a corresponding second time window of a legacy signal processing requirement.

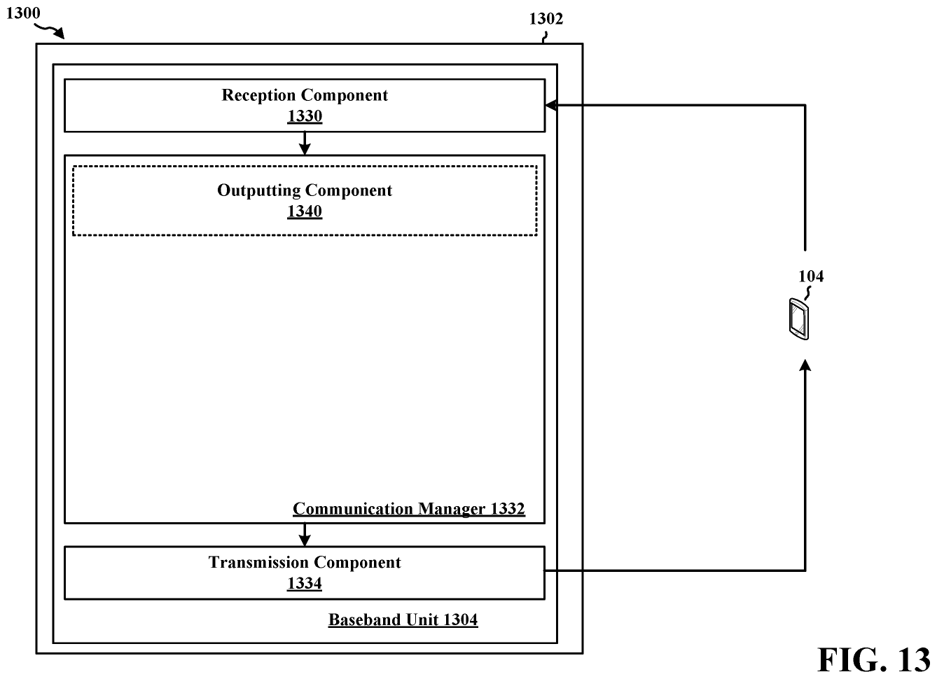

FIG. 13 is a diagram 1300 illustrating an example of a hardware implementation for an apparatus 1302. The apparatus 1302 is a wireless node and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 102/180 and may include the memory 376 and/or at least one of the TX processor 316, the RX processor 370, and the controller/processor 375.

In various examples, the apparatus 1302 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1332 includes an outputting component 1340 configured to: output a wireless signal for transmission to a second wireless node; and output, for transmission to the second wireless node, an indication of scheduled resources, wherein the scheduled resources are outside of a first time window indicated by a non-legacy signal processing requirement of the second wireless node; e.g., as described in connection with 1202 and 1204.

The apparatus may include additional components that perform each of the blocks of the algorithm in the aforementioned flowchart of FIG. 12. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes: means for outputting a wireless signal for transmission to a second wireless node; and means for outputting, for transmission to the second wireless node, an indication of scheduled resources, wherein the scheduled resources are outside of a first time window indicated by a non-legacy signal processing requirement of the second wireless node.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### Additional Considerations

Means for receiving or means for obtaining may include a receiver, such as the receive processor 356/370 and/or an antenna(s) 320/352 of the BS 102/180 and UE 104 illustrated in FIG. 3. Means for transmitting or means for outputting may include a transmitter, such as the transmit processor 316/368 and/or an antenna(s) 320/352 of the BS 102/180 and UE 104 illustrated in FIG. 3. Means for filtering and means for decoding may include a processing system, which may include one or more processors, such as the controller/processor 375/359 of the BS 102/180 and the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the terms “filtering” and/or “decoding” (or any variants thereof such as “filter” and “decode”) encompass a wide variety of actions. For example, “filtering” and/or “decoding” may include computing, processing, deriving, looking up (e.g., looking up in a table, a database or another data structure), ascertaining, sorting out, and the like.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X. Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X. Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X. Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X. Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Clause 1. A method of wireless communication at a wireless node, comprising: obtaining a wireless signal; filtering the wireless signal via an iterative interference cancelation process; and decoding the filtered wireless signal, wherein the filtering and decoding are performed within a first time window indicated by a non-legacy signal processing requirement.

Clause 2. The method of clause 1, wherein the first time window is a function of at least one of a first modulation scheme of the wireless signal or a first subcarrier spacing (SCS) of the wireless signal.

Clause 3. The method of any of clauses 1 and 2, wherein the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

Clause 4. The method of clause 3, wherein the plurality of modulation schemes comprise a first modulation range and a second modulation range, and wherein the plurality of time windows comprise at least a first subset of time windows associated with the first modulation range and a second subset of time windows associated with the second modulation range.

Clause 5. The method of any of clauses 3 and 4, wherein the plurality of modulation schemes comprise a first modulation and coding scheme (MCS) range and a second MCS range, and wherein the plurality of time windows comprise at least a first subset of time windows associated with the first MCS range and a second subset of time windows associated with the second MCS range.

Clause 6. The method of any of clauses 1-5, further comprising: obtaining an indication of scheduled resources; and outputting an acknowledgment of the wireless signal for transmission, wherein the scheduled resources are outside of the first time window indicated by the non-legacy signal processing requirement.

Clause 7. The method of any of clauses 1-6, wherein the first time window indicated by the non-legacy signal processing requirement is greater than a corresponding second time window of a legacy signal processing requirement.

Clause 8. The method of any of clauses 1-7, wherein the iterative interference cancelation process comprises one or more of a phase noise interference cancelation algorithm, an in-phase and quadrature (IQ) imbalance interference cancelation algorithm, and a non-linearity interference cancelation algorithm.

Clause 9. The method of any of clauses 1-8, wherein the wireless signal comprises one or more demodulation reference signals (DMRSs), and wherein the first time window is indicated by the non-legacy signal processing requirement in terms of contiguous symbols starting at a symbol via which a last DMRS of the one or more DMRSs is obtained by the wireless node.

Clause 10. A method of wireless communication at a first wireless node, comprising: outputting a wireless signal for transmission to a second wireless node; and outputting, for transmission to the second wireless node, an indication of scheduled resources, wherein the scheduled resources are outside of a first time window indicated by a non-legacy signal processing requirement of the second wireless node.

Clause 11. The method of clause 10, wherein the first time window is a function of at least one of a first modulation scheme of the wireless signal or a first subcarrier spacing (SCS) of the wireless signal.

Clause 12. The method of any of clauses 10 and 11, wherein the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

Clause 13. The method of clause 12, wherein the plurality of modulation schemes comprises a first modulation range and a second modulation range, and wherein the plurality of time windows comprise at least a first subset of time windows associated with the first modulation range and a second subset of time windows associated with the second modulation range.

Clause 14. The method of any of clauses 12 and 13, wherein the plurality of modulation schemes comprises a first modulation and coding scheme (MCS) range and a second MCS range, and wherein the plurality of time windows comprise at least a first subset of time windows associated with the first MCS range and a second subset of time windows associated with the second MCS range.

Clause 15. The method of any of clauses 10-14, wherein the first time window indicated by the non-legacy signal processing requirement is greater than a corresponding second time window of a legacy signal processing requirement.

Clause 16. A user equipment (UE), comprising: a transceiver; one or more memories, individually or in combination, having instructions; and one or more processors, individually or in combination, configured to execute the instructions and cause the UE to perform a method in accordance with any one of examples 1-9, wherein the transceiver is configured to: receive the wireless signal.

Clause 17. A network entity, comprising: a transceiver; one or more memories, individually or in combination, having instructions; and one or more processors, individually or in combination, configured to execute the instructions and cause the network entity to perform a method in accordance with any one of examples 10-15, wherein the transceiver is configured to: transmit the wireless signal to the second wireless node; and transmit the indication of scheduled resources to the second wireless node.

Clause 18. An apparatus for wireless communications, comprising means for performing a method in accordance with any one of examples 1-9.

Clause 19. An apparatus for wireless communications, comprising means for performing a method in accordance with any one of examples 10-15.

Clause 20. A non-transitory computer-readable medium comprising instructions that, when executed by an apparatus, cause the apparatus to perform a method in accordance with any one of examples 1-9.

Clause 21. A non-transitory computer-readable medium comprising instructions that, when executed by an apparatus, cause the apparatus to perform a method in accordance with any one of examples 10-15.

Clause 22. An apparatus for wireless communications, comprising: one or more memories, individually or in combination, having instructions; and one or more processors, individually or in combination, configured to execute the instructions and cause the apparatus to perform a method in accordance with any one of examples 1-9.

Clause 23. An apparatus for wireless communications, comprising: one or more memories, individually or in combination, having instructions; and one or more processors, individually or in combination, configured to execute the instructions and cause the apparatus to perform a method in accordance with any one of examples 10-15.

What is claimed is:

1. A method of wireless communication at a wireless node, comprising:
obtaining a wireless signal;
filtering the wireless signal via an iterative interference cancelation process; and
decoding the filtered wireless signal, wherein the filtering and decoding are performed within a first time window indicated by a non-legacy signal processing requirement.

2. The method of claim 1, wherein the first time window is a function of at least one of a first modulation scheme of the wireless signal or a first subcarrier spacing (SCS) of the wireless signal.

3. The method of claim 1, wherein the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

4. The method of claim 3, wherein the plurality of modulation schemes comprise a first modulation range and a second modulation range, and wherein the plurality of time windows comprise at least a first subset of time windows associated with the first modulation range and a second subset of time windows associated with the second modulation range.

5. The method of claim 3, wherein the plurality of modulation schemes comprise a first modulation and coding scheme (MCS) range and a second MCS range, and wherein the plurality of time windows comprise at least a first subset of time windows associated with the first MCS range and a second subset of time windows associated with the second MCS range.

6. The method of claim 1, further comprising:
obtaining an indication of scheduled resources; and
outputting an acknowledgment of the wireless signal for transmission, wherein the scheduled resources are outside of the first time window indicated by the non-legacy signal processing requirement.

7. The method of claim 1, wherein the first time window indicated by the non-legacy signal processing requirement is greater than a corresponding second time window of a legacy signal processing requirement.

8. The method of claim 1, wherein the iterative interference cancelation process comprises one or more of a phase noise interference cancelation algorithm, an in-phase and quadrature (IQ) imbalance interference cancelation algorithm, and a non-linearity interference cancelation algorithm.

9. The method of claim 1, wherein the wireless signal comprises one or more demodulation reference signals (DMRSs), and wherein the first time window is indicated by the non-legacy signal processing requirement in terms of contiguous symbols starting at a symbol via which a last DMRS of the one or more DMRSs is obtained by the wireless node.

10. A method of wireless communication at a first wireless node, comprising:
outputting a wireless signal for transmission to a second wireless node; and
outputting, for transmission to the second wireless node, an indication of scheduled resources, wherein the scheduled resources are outside of a first time window indicated by a non-legacy signal processing requirement of the second wireless node.

11. The method of claim 10, wherein the first time window is a function of at least one of a first modulation scheme of the wireless signal or a first subcarrier spacing (SCS) of the wireless signal.

12. The method of claim 10, wherein the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

13. The method of claim 12, wherein the plurality of modulation schemes comprises a first modulation range and a second modulation range, and wherein the plurality of time windows comprise at least a first subset of time windows associated with the first modulation range and a second subset of time windows associated with the second modulation range.

14. The method of claim 12, wherein the plurality of modulation schemes comprises a first modulation and coding scheme (MCS) range and a second MCS range, and wherein the plurality of time windows comprise at least a first subset of time windows associated with the first MCS range and a second subset of time windows associated with the second MCS range.

15. The method of claim 10, wherein the first time window indicated by the non-legacy signal processing requirement is greater than a corresponding second time window of a legacy signal processing requirement.

16. An apparatus for wireless communication, comprising:
one or more memories, individually or in combination, having instructions; and
one or more processors, individually or in combination, configured to execute the instructions and cause the apparatus to:
obtain a wireless signal;
filter the wireless signal via an iterative interference cancelation process; and
decode the filtered wireless signal, wherein the filtering and decoding are performed within a first time window indicated by a non-legacy signal processing requirement.

17. The apparatus of claim 16, wherein the first time window is a function of at least one of a first modulation scheme of the wireless signal or a first subcarrier spacing (SCS) of the wireless signal.

18. The apparatus of claim 16, wherein the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

19. The apparatus of claim 18, wherein the plurality of modulation schemes comprise a first modulation range and a second modulation range, and wherein the plurality of time windows comprise at least a first subset of time windows associated with the first modulation range and a second subset of time windows associated with the second modulation range.

20. The apparatus of claim 18, wherein the plurality of modulation schemes comprise a first modulation and coding scheme (MCS) range and a second MCS range, and wherein the plurality of time windows comprise at least a first subset of time windows associated with the first MCS range and a second subset of time windows associated with the second MCS range.

21. The apparatus of claim 16, wherein the one or more processors,
individually or in combination, are further configured to cause the apparatus to:
obtain an indication of scheduled resources; and
output an acknowledgment of the wireless signal for transmission, wherein the scheduled resources are outside of the first time window indicated by the non-legacy signal processing requirement.

22. The apparatus of claim 16, wherein the first time window indicated by the non-legacy signal processing requirement is greater than a corresponding second time window of a legacy signal processing requirement.

23. The apparatus of claim 16, wherein at least one of:
the iterative interference cancelation process comprises one or more of a phase noise interference cancelation algorithm, an in-phase and quadrature (IQ) imbalance interference cancelation algorithm, and a non-linearity interference cancelation algorithm, or
the wireless signal comprises one or more demodulation reference signals (DMRSs), wherein the first time window is indicated by the non-legacy signal processing requirement in terms of contiguous symbols starting at a symbol via which a last DMRS of the one or more DMRSs is obtained by the apparatus.

24. The apparatus of claim 16, further comprising a transceiver configured to:
receive the wireless signal, wherein the apparatus is configured as a user equipment (UE).

25. An apparatus for wireless communication, comprising:
one or more memories, individually or in combination, having instructions; and
one or more processors, individually or in combination, configured to execute the instructions and cause the apparatus to:
output a wireless signal for transmission to a wireless node; and
output, for transmission to the wireless node, an indication of scheduled resources, wherein the scheduled resources are outside of a first time window indicated by a non-legacy signal processing requirement of the wireless node.

26. The apparatus of claim 25, wherein the first time window is a function of at least one of a first modulation scheme of the wireless signal or a first subcarrier spacing (SCS) of the wireless signal.

27. The apparatus of claim 25, wherein the non-legacy signal processing requirement is indicative of a plurality of time windows including the first time window, and wherein each of the plurality of time windows is mapped to at least one of: one of a plurality of modulation schemes or one of a plurality of subcarrier spacings (SCSs).

28. The apparatus of claim 27, wherein the plurality of modulation schemes comprises a first modulation range and a second modulation range, and wherein the plurality of time windows comprise at least a first subset of time windows associated with the first modulation range and a second subset of time windows associated with the second modulation range.

29. The apparatus of claim 27, wherein at least one of:
the plurality of modulation schemes comprises a first modulation and coding scheme (MCS) range and a second MCS range, wherein the plurality of time windows comprise at least a first subset of time windows associated with the first MCS range and a second subset of time windows associated with the second MCS range, or
the first time window indicated by the non-legacy signal processing requirement is greater than a corresponding second time window of a legacy signal processing requirement.

30. The apparatus of claim 25, further comprising a transceiver configured to:
transmit the wireless signal; and
transmit the indication of scheduled resources, wherein the apparatus is configured as a network entity.
